(19) United States
(12) Patent Application Publication
(10) Pub. No.: US 2016/0335544 A1
(43) Pub. Date: Nov. 17, 2016

(54) Method and Apparatus for Generating a Knowledge Data Model

(71) Applicants: Claudia Bretschneider, Munchen (DE); Heiner Oberkampf, Munchen (DE); Sonja Zillner, Munchen (DE)

(72) Inventors: Claudia Bretschneider, Munchen (DE); Heiner Oberkampf, Munchen (DE); Sonja Zillner, Munchen (DE)

(21) Appl. No.: 14/710,380

(22) Filed: May 12, 2015

(51) Int. Cl. G06N 5/02; G06F 17/30

(52) U.S. Cl. CPC G06N 5/022; G06F 17/30734; G06F 17/30631

(57) ABSTRACT

A method for generating a knowledge data model is provided. The method includes providing at least one initial set of semantic type entities of a specific semantic type. The initial set of semantic type entities is expanded using available mappings between entities of the initial set and entities of unspecified type to generate an extended set of semantic type entities. Entities of a same semantic type are clustered within the extended set of semantic type entities. The method maps semantic relations between entities of different semantic type to relations between corresponding clusters containing the entities to generate the knowledge data model.

### TECHNICAL FIELD

The disclosed embodiments relate to a method and apparatus for generating a knowledge data model.

### BACKGROUND

Linked data may be based on standard Web technologies, such as Hypertext Transfer Protocol (HTTP), Resource Description Framework (RDF) and Uniform Resource Identifier (URI). The Uniform Resource Identifier URI may be used to denote entities. Using HTTP, URIs may be used so that entities may be referred to and looked up by a user and a user's agents. Useful information about the entity can be provided by standards, such as RDF or SPARQL, when the URI of the entity is looked up. When data is published on the Internet, links to other related entities are included using respective URIs for the other related entities.

On the Internet, many valuable ontologies and knowledge resources are available as part of a Linked Open Data Cloud (LOD). The Semantic Web gathers and interlinks all kinds of useful publicly available web information from any domain in the LOD Cloud, which forms a collection of interlinked datasets. Each dataset may represent a specific domain or topic of interest, and each dataset may contain the data published and maintained by a single provider. These datasets use Semantic Web Technologies such as RDF, SPAQRL and Web Ontology Language (OWL) to represent and access information.

The LOD Cloud includes a plurality of structured and semantically annotated data sources from various different technical domains, such as life science, geography, science, media, etc. The LOD Cloud may form a useful resource for any kind of data-based applications (e.g., analytic applications and search applications). Most knowledge-based industrial applications rely on LOD knowledge resources and multiple ontologies and knowledge resources. Consequently, the integration of knowledge from one or different LOD knowledge resources may provide a significant benefit in various domains. However, a shortcoming of conventional LOD knowledge resources is the limited degree of semantic integration. The repositories of the LOD Cloud commonly provide access to hosted ontologies or datasets through public available SPARQL endpoints or HTTP APIs. Any entity contained in a LOD repository may be identified by an URI, and corresponding semantics may be expressed through relations to other entities using object properties and through attributes using data and annotation properties (e.g., for labels or textual definitions).

In the Linked Open Data Cloud, the different knowledge resources are not semantically aligned to each other because most of the existing data resource schemas and ontologies are not based on common semantics. Even though various mapping algorithms and corresponding mapping resources are available, the semantics of the semantic type information (e.g., the meta description of the entities) is not globally agreed upon or aligned for several reasons. For example, there is no agreed upon target schema for semantic type relationships. Further, object properties are used in different contexts, often without a clear domain and range specification, and with vague semantics. Abbreviations and identifiers are used in property URIs and labels, hindering the establishment of automatic mapping techniques.

Additionally, users often face a situation where the required semantic type information is only available for a single LOD resource. For example, meta-labels classifying disease and symptom concepts are covered within the UMLS ontologies as part of the LOD cloud.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a seamless cross-LOD resource knowledge access and a seamless interpretation of cross-resource query description across multiple resources are provided.

According to a first aspect, a method for generating a knowledge data model is provided. The method includes providing at least one initial set of semantic type entities of a specific semantic type; expanding the initial set of semantic type entities using available mappings between entities of the initial set and entities of unspecified type to generate an extended set of semantic type entities; clustering entities of the same semantic type within the extended set of semantic type entities; and mapping of semantic relations between entities of different semantic type to relations between corresponding clusters containing the entities to generate the knowledge data model. One or more acts of the method may be executed by a processor. For example, the processor may map the semantic relations between entities of different semantic type to relations between corresponding clusters containing the entities to generate the knowledge data model.

The method according to an embodiment allows for automated extraction of information or data from the LOD cloud to build a knowledge data model that is relevant to a particular industrial domain.

In an embodiment of the method, the mappings used for expanding the initial set of semantic type entities include ontology mappings of ontologies.

In an embodiment of the method, the ontology mappings used are relations between entities of different ontologies that define an equivalence between two different entities.

In an embodiment of the method, entities of an unspecified type are extracted from knowledge resources forming part of a linked open data cloud.

In an embodiment of the method, unstructured textual resources containing text-based documents are integrated automatically in the linked open data cloud.

In an embodiment of the method, the unstructured text of the textual resources is linguistically and semantically processed using a semantic data model to extract semantic type entities.

In an embodiment of the method, the extracted semantic type entities are mapped on linked open data entities using string matching and are transformed into triple formats extended with links to the linked open data cloud.

In an embodiment of the method, the initial set of semantic type entities includes an initial disease set and/or an initial symptom set.

In an embodiment of the method, the generated knowledge data model is output as a knowledge data model graph and/or is stored in a database for further processing.

In a second aspect, an apparatus for automatically generating a knowledge data model is provided. The apparatus includes: a loading unit configured to load at least one initial set of semantic type entities of a specific semantic type from a database; and a calculation unit configured to expand the loaded initial sets of semantic type entities using available mappings between entities of the initial sets and entities of unspecified type to generate an extended set of semantic type entities. The calculation unit is further configured to cluster entities of a same semantic type within the extended set of semantic type entities. Semantic relations between entities of different semantic type are mapped to relations between corresponding clusters containing the entities to generate the knowledge data model. The semantic relations may be mapped by the calculation unit. The calculation unit may be or may include one or more processors.

In an embodiment of the apparatus, the mappings include ontology mappings of ontologies stored in the database.

In an embodiment of the apparatus, the entities of unspecified type are extracted from resources forming part of a linked open data cloud, to which the apparatus is connected via a data interface.

In an embodiment of the apparatus, the generated knowledge data model is output as a knowledge data model graph via a graphical user interface of the apparatus and/or is stored in a database for further processing.

In a third aspect, a linked open data cloud system including a plurality of linked data resources and at least one apparatus for generating a knowledge data model is provided. The apparatus includes: a loading unit configured to load at least one initial set of semantic type entities of a specific semantic type from a database; and a calculation unit configured to expand the loaded initial sets of semantic type entities using available mappings between entities of the initial set and entities of unspecified type to generate an extended set of semantic type entities. The calculation unit is further configured to cluster entities of a same semantic type within the extended set of semantic type entities. Semantic relations between entities of different semantic type are mapped to relations between corresponding clusters containing the entities to generate the knowledge data model. The calculation unit may be or may include one or more processors.

In a fourth aspect, a model generation software tool for automatically generating a knowledge data model is provided. The model generation tool includes program instructions executable to perform a method for generating a knowledge data model, including the acts of: loading at least one initial set of semantic type entities of a specific semantic type; expanding the initial set of semantic type entities using available mappings between entities of the initial set and entities of unspecified type to generate an extended set of semantic type entities; clustering entities of a same semantic type within the extended set of semantic type entities; and mapping of semantic relations between entities of different semantic type to relations between corresponding clusters containing the entities to generate the knowledge data model. The model generation tool may include a non-transitory computer-readable storage medium that includes the program instructions executable by one or more processor to perform the method for generating the knowledge data model.

In a fifth aspect, a data carrier that stores such a model generation software tool for automatically generating a knowledge data model is provided.

### BRIEF DESCRIPTION OF THE DRAWINGS

FIG. 1 depicts a flowchart of an exemplary embodiment of a method for generating a knowledge data model.

FIG. 2 depicts a block diagram of an exemplary embodiment of an apparatus for automatically generating a knowledge data model.

FIG. 3 depicts a schematic diagram for illustrating an exemplary embodiment of the method for generating a knowledge data model.

FIGS. 4 and 5 depict a disease and symptom graph for illustrating clustering results in an exemplary use case for illustrating the operation of the method and apparatus according to an exemplary embodiment.

FIG. 6 depicts a diagram for illustrating the generation of a knowledge data model by the method and apparatus according to an exemplary embodiment.

FIG. 7 depicts a diagram for illustrating an exemplary implementation of integrating unstructured resources in a linked open data cloud according to an embodiment of the apparatus and method.

### DETAILED DESCRIPTION

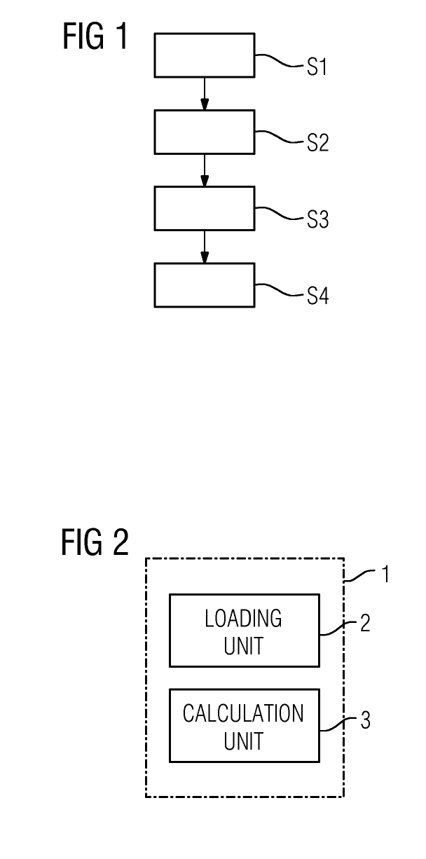

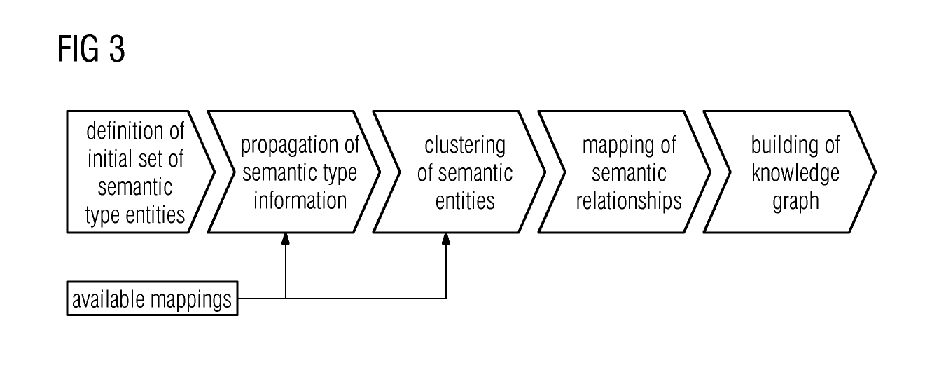

FIG. 1 depicts a flowchart of an exemplary embodiment of a method for generating a knowledge data model (KDM).

In act S1, at least one initial set of semantic type entities of a specific semantic type is provided. The number of initial sets of semantic type entities may vary. For example, an initial disease set and an initial symptom set may be loaded from a database. The method relies on an initial set of LOD knowledge resources that encompass the semantic type information that is relevant to a particular industrial application in a specific technical domain. For example, disease and symptom type information that is relevant when developing a knowledge-based clinical decision support system is covered (e.g., within the Unified Medical Language System UMLS related LOD resources).

Entities describe concrete classes or instances defined in some ontologies or knowledge models. The term semantic type information describes a commonly agreed upon category, such as a disease or a symptom that may be used to classify entities. Entities that are labeled with the same semantic type information are called semantic types or semantic type entities (e.g., disease type entities or symptom type entities). The relationship between entities is a semantic relationship or semantic relation. In various ontology description languages, such as OWL or RDF, semantic relationships are referred to as object properties. Semantic relationships between semantic types are referred to as semantic type relationships. The term semantic label describes the semantic of an entity or thing on a conceptual level without reference to any concrete implementation, such as an ontology. Entities that are provided with a semantic label are semantic entities. To provide an initial set of semantic type entities of a specific semantic type, semantic types are defined, suitable LOD knowledge resources are identified and related available ontology mappings are selected. When defining the semantic type information, it is decided which information categories (e.g., semantic type information) are relevant for the respective application. For example, two kinds of semantic type information may be selected, such as the information categories “disease” and “symptom.” LOD knowledge resources covering the selected semantic types are identified. For example, for the information categories “disease” and “symptom,” an initial disease set and initial symptom set are identified on available LOD resources.

For example, an initial disease set may include all entities of Disease Ontology (DO) and entities of UMLS ontologies classified as “disease or syndrome.” In total, the initial disease set may contain, for example, more than 150,000 entities from 18 different ontologies. In this example, the entities may be labeled as entities of type disease or disease type entities. Further, an initial symptom set may include, for example, all entities of Symptom Ontology (SYMP) and entities of UMLS ontologies classified as “sign or symptom.” In total, the initial set may contain more than 14,000 entities from 18 different ontologies. In this example, the entities may be labeled as entities of type symptom or symptom type entities.

In an optional act after act S1, double assignments may be eliminated. Double assignments of entities (e.g., entities that are of semantic type information, such as entities of type disease and of type symptom) are likely to occur due to the heterogeneity of the LOD cloud. The elimination of double assignments may be beneficial. The optional elimination act may be performed manually or automatically. Manually eliminating double assignments may be performed by an expert consultation. For all entities with a double assignment, an expert may select a semantic type for that entity based, for example, on the preferred label information. As an alternative, an automatic approach for removing double assignments may be provided. Automatically eliminating double assignments may be performed by defining a similarity measure that incorporates the degree of connectedness of particular entities to other semantic type entities. For example, ontology mappings or subclass relationships may be used.

As depicted in the flowchart of FIG. 2, in act S2, the initial set of semantic type entities is expanded using available mappings between entities of the initial set and entities of an unspecified type to generate an extended set of semantic type entities. In an embodiment, the mappings are used to expand the initial set of semantic type entities to include ontology mappings of ontologies. In another embodiment, related ontology mappings are selected. For example, the BioPortal encompasses a valuable set of ontology mappings that may be used. This embodiment is not restricted to using the BioPortal ontology mapping, but may reuse any set of ontology mappings that are specified. Because the quality and appropriateness of reused ontology mappings significantly influence the quality and appropriateness of the developed final knowledge data model, the selection of ontology mappings may be accomplished by a domain expert for the respective technical domain.

In act S2, the knowledge base of entities (e.g., the initial sets of semantic type entities) is extended. In an exemplary use case, disease type entities and symptom type entities covered within other LOD resources are identified. In order to identify entities of a particular semantic type, existing available mappings (e.g., ontology mappings) are used to retrieve more entities of the same semantic types. An underlying assumption is that entities that may be mapped to each other via at least one existing mapping are semantically similar or equivalent. The semantic equivalence information is reused in act S2 by propagating the semantic type information of entities of the initial set of semantic type entities to any other entity to which there exists at least one instance of an ontology mapping. For example, if at least one instance of an ontology mapping belonging to the selected set of ontology mappings exists, the mapped target entity is labeled with the semantic type of the mapped source entity.

In act S2, mappings are used to assign a semantic type to entities that have no corresponding semantic type assigned. The ontology mappings include relations between entities of different ontologies that denote similarity or equivalence of two entities. In an embodiment, a mapping specifies at least a target entity, a target ontology, a source entity, a source ontology and a relation type. For example, in an exemplary use case, the BioPortal may contain different mapping resources. The Unified Medical language system (UMLS) is a system for integrating major vocabularies and standards from the biomedical domain. Further, the human disease ontology (DO) represents a comprehensive knowledge base of inherited, developmental and acquired diseases. With the initial sets for diseases and symptoms, the existing mappings on BioPortal may be used to retrieve more entities of the same semantic types. It may be assumed that entities being mapped to each other via at least one existing mapping are semantically similar. This semantic equivalence information is reused in act S2 of the method according to the first aspect by propagating the semantic type information of the initial set of entities to each of the mapped entities. For example, an entity is in the set of potential diseases if there is a mapping to an entity of the initial disease set. For example, this may result in more than 240,000 entities from more than 200 ontologies for diseases and more than 30,000 entities from more than 160 ontologies for symptoms. However, the resulting sets of entities may overlap.

In an embodiment, the method determines a single semantic type for entities that overlap. An entity in the initial set is deemed to be more relevant than an entity in a potential set. Further, for entities that overlap with potential disease and potential symptom sets, a classification may be made based on the number of mappings to entities of the different initial sets. For example, if for a corresponding entity, there are more mappings to entities of the initial disease set than to entities of the initial symptom set, then the entity is assigned the semantic type disease. If there are more mappings to entities of the initial symptom set than to entities of the initial disease set, the entity is assigned to the semantic type symptom. For example, after this separation act, there may be, for example, more than 240,000 disease entities left and more than 23,000 symptom entities left.

After having expanded this initial set of semantic type entities in act S2, in act S3, entities of a same semantic type are clustered with the extended set of semantic type entities. The propagation performed in act S2 results in a large set of semantic type entities (e.g., in the use case, entities of disease type and entities of symptom type). Although these larger sets of entities are labeled with the same semantic type information, the labels do not imply that the entities labeled with the same semantic type information are of the same category. Instead, entities labeled with the same semantic type information may represent different semantic concepts. In the exemplary use case, a set of disease type entities may cover all entities that are provided with a semantic label describing a particular disease, such as cancer, lymphoma or a cold. Further, a set of symptom type entities may cover any entity that is provided with a semantic label describing a particular symptom, such as a fever, night sweats, or weight loss. Many of the semantic type entities identified in act S2 describe the same semantic concept (e.g., semantic type entities are provided with a similar or synonymous semantic label). For example multiple disease type entities describe the semantic concept “Hodgkin disease.”

In act S3, all semantic entities describing the same semantic concept (e.g., entities that provide a similar or synonymous semantic label) are clustered. The selected set of ontology mappings used in act S1 may be reused to identify clusters or groups of entities with a conceptually same semantic label. For example, in the exemplary use case application building a disease symptom knowledge data model, only the two ontology mappings, “loom” and “UMLS/CUI” from the BioPortal, are relevant (e.g., the relevant mappings have corresponding entities, such as a source or target). In an embodiment, large clusters are avoided because large clusters increase the likeliness of encompassing entities representing different semantic concepts. An exemplary algorithm for clustering entities may be based on basic constraints, as follows. If a path in the ontology mappings in the graph exists between two entities, the two entities form candidates for belonging to the same cluster. Further, each cluster may only encompass one entity of the same ontology.

In an embodiment, the clustering algorithm works as follows. For each semantic type, the clustering algorithm iterates over all corresponding semantic type entities:

Definitions:

A: set of entities to be processed;

A(ci): set of entities to be processed for cluster ci;

ont(ci): set of ontologies that contain ci;

ont(ci): set of ontologies that contain an entity e that is contained in the cluster ci;

map(ei): the set of entities that have a mapping to ei and that are in the set of entities to be processed A.

In a sub-act of the clustering algorithm, the clusters ci are initialized. One entity ei is selected from set A to create a cluster ci. An entity ei is added to cluster ci and to the set A(ci), then the entity ei is removed from the set A of entities to be processed.

In another sub-act, for each entity e of A(ci), all mapped entities that are not processed are retrieved (e.g., map(e)). For each entity ej in map(e), the clustering algorithm performs the following: if ont(ej) and ont(ci) are disjoint, then ej is added to cluster ci and to A(ci), and ej is removed from the set A. In this manner, one cluster contains only one entity per ontology. Next, ont(ej) is added to ont(ci).

The cluster ci is finished when A(ci) does not contain any entities. Further, the clustering algorithm is finished when the set A does not contain any entities.

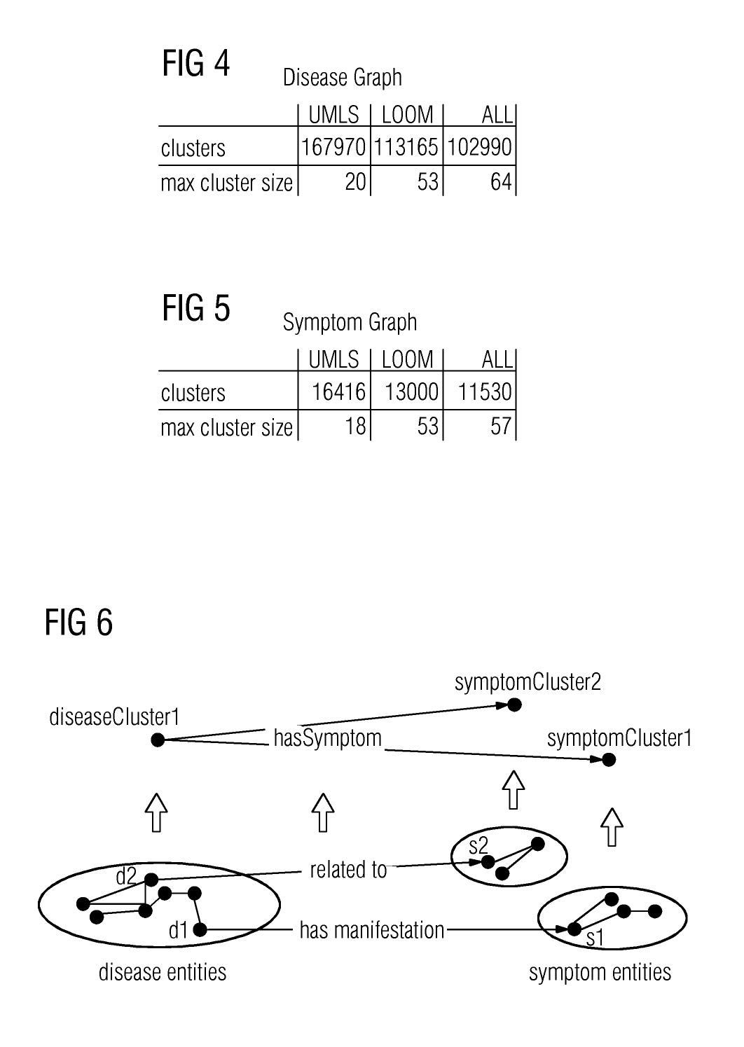

FIGS. 4 and 5 depict exemplary clustering results for an exemplary use case implementation provided in a table.

After the clustering in act S3 is complete, mapping of semantic relationships may be performed. Mapping of semantic relationships is performed to describe the related semantic type relationships that occur between the semantic entities type in an explicit manner. For example, in the exemplary use case of entities of disease type and entities of symptom type, given a large set of entities of two particular semantic types, extraction of disease-symptom relationships (e.g., semantic type relationships) may be provided as follows. For each ontology (e.g., LOD knowledge resources selected in act S1) containing semantic type entities for both selected semantic type information, the related semantic type information that is used to semantically label the semantic type relationships between the two semantic type entities (e.g., the relationships between entities of type disease and entities of type symptom, or vice versa) is extracted. For example, in the exemplary use case, 33 distinct relationship type information from diseases to symptoms, and 42 distinct relationship type information from symptoms to diseases may be found.

Using the set of extracted labels of the semantic type relationships, a relationship taxonomy may be constructed by consulting a domain expert. A domain expert is consulted to semantically structure or group related relationship types, such as “sibling” relationships or “hasSymptom” relationships.

An exemplary relationship taxonomy for the exemplary use case implementation is illustrated below:

sibling

MDR/SIB
RCD/SIB
WHO/SIB
MSH/SIB
MEDLINEPLUS/SIB
ICD9CM/SIB
ICD10CM/SIB
CSP/SIB

hasSymptom

OMIM/has_manifestation
MEDLINEPLUS/related_to
SNOMEDCT/cause_of
RN
WHO/RN
CSP/RN

rdfs:subClassOf

WHO/RB
CSP/RB
RO
CSP/RO
MSH/RO

skos:exactMatch

SNOMEDCT/same_as
MSH/mapped_to

replaces

SNOMEDCT/replaces
ICPC2P/replaces
SNOMEDCT/replaced_by
SNOMEDCT/occurs_before
SNOMEDCT/occurs_after
SNOMEDCT/may_be_a
SNOMEDCT/is_alternative_use
SNOMEDCT/associated_finding_of
SNOMEDCT/associated_morphology_of
SNOMEDCT/interprets
MDR/classified_as
MDR/classifies
ICPC2P/replaced_by

In an embodiment, the expert consultation is automated. A pattern matching algorithm allowing grouping of labels of semantic type relationships in accordance with a pattern of the corresponding related instance set of semantic relationships is used. For example, a string matching algorithm may be used to automatically create a relationship taxonomy. Similarly, domain and range definitions of relationships to be aligned may be included.

In act S4, cluster information and the taxonomy of semantic type relationships are used to generate a final knowledge data model. In act S4, semantic relations between entities of different semantic type are mapped to relations between corresponding clusters containing these entities to generate the knowledge data model (KDM).

Based on the semantic relationships between entities (e.g., entity-level relations) and the relationship taxonomy, cluster level relationships may be created. As illustrated in FIG. 6, cluster level relationships are created by aggregating available relationships from entity level on cluster level. As illustrated in FIG. 6, on the entity level, there are two relations between “d1 hasmanifestation s1” and “d2 related to s2”, where d1 and d2 are disease entities, and s1 and s2 are symptom entities. As illustrated in FIG. 6, on the cluster level, there is only one disease cluster that has two relations to two different symptom clusters. This provides that relations that were defined for the two different disease entities (in different ontologies) are now aggregated for one disease cluster. Consequently, information from the different ontologies is available in one cluster and may be easily queried.

The mapping act S4 may also include several sub-acts. For example, all semantic type entities may be stored as URIs, and the corresponding semantic type is assigned to the semantic type entities by storing a disy:semanticType relationship the semantic type (e.g., disy:Disease or disy:Symptom).

Each entity is connected to the ontology in which the entity originally occurs by relationship disy:sourceOntology. For example, an entity may occur in one or many different ontologies or data sets. Each entity is related to a corresponding cluster by the relationship disy:containedInCluster. Mappings between entities are represented by relations that are named by the mapping sources so that different mappings may be distinguished. In addition, these relationships are defined as subproperties of skos:exactMatch in order to easily query all mappings without discriminating sources.

For each semantic type entity, preferred labels are stored as a string using skos:prefLabel relationship. For each cluster, a preferred label may be selected based on the frequency of preferred labels of the contained entities. In case of multiple labels occurring with the same frequency, the longest label is selected. An entity may have one or more preferred labels. Structural relationships, such as subClassOf, that were defined between entities in the source ontologies may also be preserved in the knowledge data model, as the structural relationships allow hierarchical navigation between clusters.

Relations between entities are extended by relationships between corresponding clusters. For each relationship between two entities, the corresponding super-relationship from the established relationship taxonomy is created between the corresponding clusters. An example is shown in FIG. 6. As illustrated in FIG. 6, two entities d1 and s1 are connected by the relationship hasmanifestation, and a super-property in the relationship taxonomy is “hasSymptom.” The clusters of d1 and s1 are diseaseCluster1 and symptomCluster1, respectively. Thus, a relationship “hasSymptom” between diseaseCluster1 and symptomCluster1 has been created.

After the knowledge data model is generated, all disease symptom relations and different labels of a disease or symptom concept may be retrieved. As illustrated in FIG. 1, a procedure that allows an application-focused knowledge data model to be extracted from LOD knowledge resources may be established. Semantic type information propagation allows reuse of established semantic categories while propagating the semantic labels across other related LOD knowledge resources. The establishment of a relationship taxonomy based on the sets of semantic type entities may be automated by applying string matching algorithms on the relationship labels and by also using domain and range specifications of the relationships if the specifications are available.

Aggregating entity-level relations on a cluster level is based on a relationship taxonomy. The clustering approach may be determined by the created relationship taxonomy. However, a more generic approach may rely on any suitable knowledge data model that covers a related relationship taxonomy allowing for coordinating the clustering process.

FIG. 2 depicts an exemplary apparatus for automatically generating a knowledge data model (KDM). As illustrated in FIG. 2, an apparatus 1 is provided for automatically generating a knowledge data model. The apparatus 1 includes a loading unit 2 and a calculation unit 3. The loading unit 2 is configured to load an initial set of semantic type entities of a specific semantic type from a database. The calculation unit 3 of the apparatus 1 is configured to expand the loaded initial sets of semantic type entities using available mappings (e.g., ontology mappings) between entities e of the initial sets and entities e of unspecified type to generate an extended set of semantic type entities. The calculation unit 3 is further configured to cluster entities of the same semantic type within the extended set of semantic type entities. Semantic relations between entities of different semantic type are mapped to relations between corresponding clusters containing the entities to generate the knowledge data model (KDM). The entities e of the unspecified type may be extracted from resources forming part of a linked open data (LOD) cloud. The LOD cloud is connected to the apparatus 1 via data interface. The generated knowledge data model may be output as a knowledge data model graph via a graphical user interface of the apparatus 1. Further, the generated knowledge data model may be stored in a database for further processing.

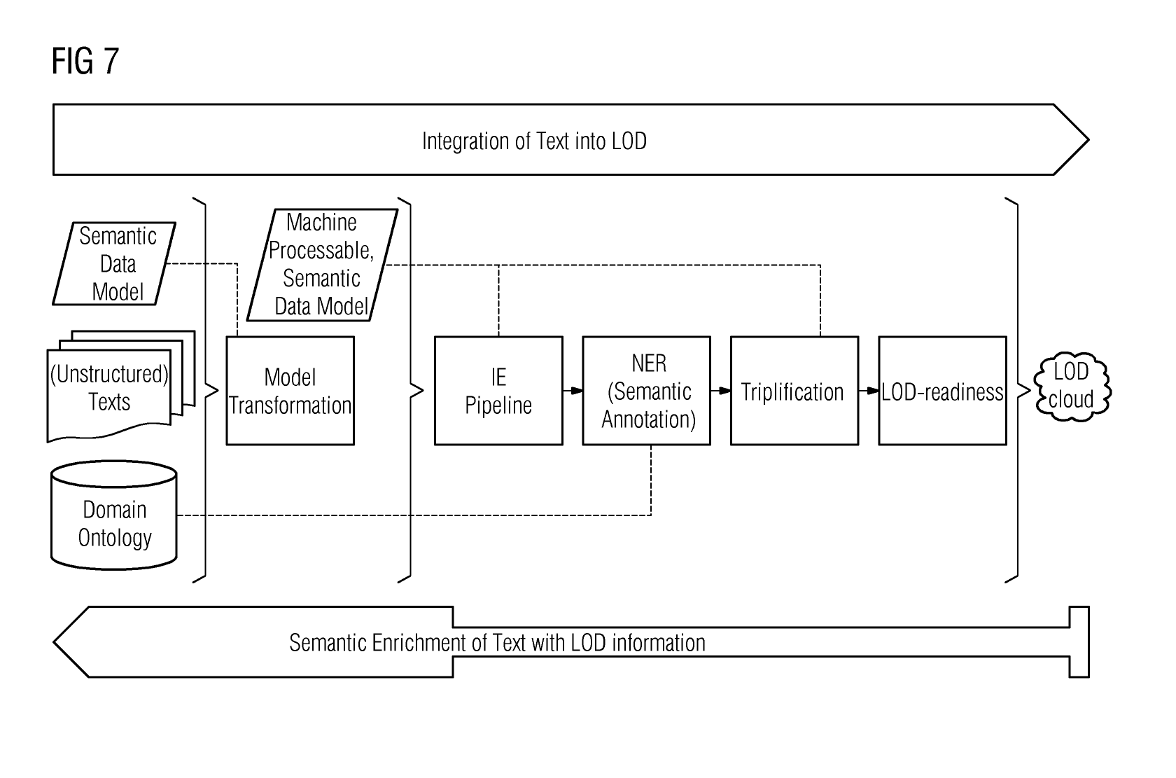

In an embodiment, unstructured textual resources containing text-based documents are integrated in the linked open data (LOD) cloud. In an embodiment, the unstructured text of the textual resources is linguistically and semantically processed using a semantic data model to extract semantic type entities. The extracted semantic type entities are mapped on linked open data entities using a string matching and are transformed into triple formats that are extended with links to the linked open data (LOD) cloud. In this embodiment, a mechanism for seamlessly integrating the content of unstructured, text-based data sources into the LOD cloud is provided. This seamless integration of the unstructured text-based data sources is performed automatically. The extracted semantic annotation from unstructured texts is interlinked with the existing structured information in the LOD cloud. In this embodiment, the linking mechanism establishes a basis to enhance the LOD cloud with additional information and enhances the texts' semantic annotations with structured context information from the LOD cloud. FIG. 7 illustrates the seamless integration of unstructured text resources into the LOD cloud. For seamless integration, the structured information enclosed in the unstructured textual resources are extracted. Entities from existing LOD datasets are detected in the unstructured text to link the newly extracted structured information with existing structured information (NER) and thus serves the purpose of growing the information in the LOD cloud. The extracted structured information is then transformed into semantic content (e.g., semantic representation), triplification. The newly created information is linked to the existing graph information pieces, growing the information cloud. The integration process performed in this exemplary embodiment uses as input resources at least one unstructured textual resource, a LOD domain ontology, and a semantic data model.

Most information available on the Internet is represented in unstructured formats (e.g., text-based documents). In the integration process illustrated in FIG. 7, text-based documents and the information contained in the text-based documents are used to enrich the content of already available LOD datasets or may be used to create a new interlinked dataset within the LOD cloud. The unstructured text may include any free data format and may contain valuable information for enriching the LOD cloud. The information contained in the unstructured text may include single pieces information, entities or relations between entities. By finding LOD entities in the text and using the information contained in the unstructured text while creating RDF triples, the linking to the LOD cloud may be established.

The semantic data model (SDM) illustrated in FIG. 7 serves as a template defining the entities that are to be extracted from the text-based documents, thus specifying the domain semantics. These covered entities may be of relevance for an application according to this embodiment.

For automatically transforming the semantic data model (SDM) into the internal representation format (e.g., for the IE pipeline), the following properties may be required: the semantic data model (SDM) may be described using semantic web technologies such as OWL/RDF; the semantic data model (SDM) defines concepts and contained attributes; each attribute is specified with a name and primitive data type of valid values; the data type is a standard type defined in the RDF specification (user-defined data types are not allowed); relations between concepts express a directed interdependence between two concepts using a relationship name; and concepts may be related via hierarchical relations that form special relations.

Two types of semantic data models (SDMs) may be differentiated (e.g., LOD-based ontology models and non-LOD-based ontology models).

The semantic data model (SDM) may be an ontology that already exists as a pre-defined, existing model of a LOD dataset, and may already work as representation schema for entities in the respective set. An advantage of facilitating existing ontologies is that the existing ontologies are already tailored and standardized for the respective exemplary use case. Additionally, compatibility of the outcome with other information extraction pipelines increases. Using an LOD-based ontology enables seamless integration of additional content into existing LOD datasets instantly, because the existing LOD datasets are already integrated. Existing models may also be used if the goal of the information extraction is the extension of existing datasets that are already using the existing ontology as the underlying semantic data model (SDM).

When building and integrating new datasets, new semantic data models (SDMs) may be defined and used within the integration process. During modeling, special consideration may be put to integrating existing datasets in order to fulfill interlinking with the LOD cloud. For interlinking, an inter-concept relation exists with a concept of an existing LOD dataset. By integrating a model to the new dataset, the model becomes part of the LOD cloud itself.

The integration process targets the integration of domain-specific information into the LOD cloud. The underlying semantic data model (SDM) and the domain ontology (DO) are defined to be semantically correlated. As such, the semantic data model (SDM), which is domain-specific (e.g., from the medical domain), and the ontology (DO) that defines existing LOD entities describe the same domain.

The modular and generic construction of the system may enable or facilitate a simple exchange of the functional components. The three input resources used by the integration process illustrated in FIG. 7 may be exchanged without major changes to the system, allowing the system to be easily tailored to any required domain.

A preprocessing act of the integration process illustrated in FIG. 7 is provided. The preprocessing act performs the transformation of the semantic data model (SDM) (e.g., represented using Semantic Web technologies) into the executable language of the underlying pipeline.

The semantic data model (SDM) describes the knowledge categories that are relevant for an application scenario, and in accordance to this, the corresponding information entities are extracted from the textual source data.

Depending on the information extraction (IE) system extracting the defined information entities, an internal representation format is used by the information extraction system to label the extracted information entities. The semantic data model (SDM) is thus readable, interpretable and processable by the pipeline (e.g., a mapping of the semantic data model (SDM) to the international representation format is performed). The semantics described by the model remains stable. It is only the representation that is altered by this preprocessing act.

The preprocessing act is optional if the original semantic data model (SDM) exists already in a machine-processable format.

For example, when the UIMA framework is used for the information extraction (IE) pipeline, the semantic data model (SDM) is transferred into the internal UIMA data model. UIMA defines a type system for the definition of entity classes (types) and corresponding properties (features). The entities are defined by using a proprietary model represented in XML format. In addition, the definition of a hierarchical model of the types and the definition of data types is specific for the UIMA model. The result of this act is a valid UIMA type system that represents the semantics of the original semantic data model (SDM).

### Integration Step 1: Information Extraction (IE) Pipeline

In order to extract nNewly explored information may be extracted from text by processing the input text linguistically and semantically.

Act S1 may include multiple sub-acts to acquire the new information in a process referred to as a pipeline.

The semantic data model (SDM) employed informs the IE pipeline about the algorithms to be selected.

The process is instrumental with an inventory of algorithms that are semantically annotated with the information of which semantic entities the algorithms are able to extract. Therefore, the IE pipeline may automatically select the corresponding algorithms for the specific task (depending on the required semantic entities) and extract the required entities automatically. For internal representation, the extracted information is put into and handled via the internal data model.

### Integration Step 2: Named Entity Recognition (NER, Semantic Annotation)

In order to satisfy a LOD requirement of linking to existing LOD datasets, the extracted information entity is mapped onto an existing LOD entity. For example, mappings of at least 50 extracted information entities and LOD entities may be established by using simple string matching algorithms (e.g., during NER, the vocabulary of the LOD dataset is mapped against the text). If a match is found, the respective word in the text is annotated with the URI of the corresponding LOD entity.

For example, medical texts may be transformed into a LOD dataset. When linking to the existing cloud, diseases that are already listed in the ICD-10 dataset (http://bioportal.bioontology.org/ ontologies/ICD10PCS) are also recognized in the medical texts. If an occurrence of a disease concept is found in the text, the string is annotated with the information of which disease is found, and the respective disease URI is attached.

### Integration Step 3: Triplification of Text Annotations

The triplification act is performed to create a correct structural representation of the newly extracted information entities.

The new information entities are transformed into valid RDF triples. The transformation is built on the semantic data model (SDM) and the defined properties of the semantic concepts (e.g., names, data types, relations). A unique ID is calculated for each text annotation. The unique ID of the annotation is used to generate the HTTP URI. The host and path part of the URI are application-specific and defined in the semantic data model (SDM).

For example, the structured information extracted from the text (and available via the internal model) is transformed to the RDF format. Each annotation and corresponding features are transformed to a triple format, such as <annotation> <featureName> <feature Value>. For each annotation, a unique URI is created. Therefore, a unique ID is created (e.g., by using a hash code that is calculated using all available attribute names and values of the annotation) and integrated into a HTTP URI.

Integration Step 4: Transformation of Triples into LOD-Ready Representation

The RDF representation is extended with links to existing LOD datasets. The links are created by using the annotations from the NER act. For example, the links are transformed to triples that reflect the same-as relationship: <annotation> rdf:sameAs <diseaseURI>. The resulting RDF triples form the new LOD dataset.

Automating the process of extracting new LOD datasets from unstructured text resources and integrating the datasets into the cloud is a new process. Research has focused on identifying existing entities from available datasets or relations between the identified entities found in texts or extending the set of entities by additional instances identified in the text. The creation of completely new datasets and integration of the completely new datasets into the LOD cloud is a new process. New datasets may be defined as datasets that contain concepts (e.g., conceptual definitions of entity classes) and instances that have not been covered so far by other datasets.

The degree of automation introduced with the proposed integration process is new. Publishing the resulting LOD triples is the only manual intervention in the whole integration process. A full and automated coverage of all requirements for creating new LOD datasets is achieved. In conventional systems, at least one requirement is not considered to have an end-to-end process of extracting LOD-ready triples from text.

The integration process offers a high degree of generalization. Previously, processes for information extraction from texts (and subsequent RDF triple extraction) were specially designed and implemented for specific domains (or specific applications). For example, the processes were tailored for either special target models and thus require specific models and triplication processes, or for extracting entities from specific ontologies and thus require specific NER modules.

The integration process illustrated in FIG. 7 forms a generic LOD triple-extraction pipeline that may be tailored for any domain (or application) without imposing additional adaptation efforts. This is achieved by a modular pipeline, where interacting components take responsibility for a specific task or processing act.

Thus, when a single or all of the input resources are exchanged to extract datasets for other domains, the model may be adapted in order to extract a different dataset.

By pursuing this design approach, the efforts for adaptation are minimized, and a high quality system with regard to maintainability and adaptability is created.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for generating a knowledge data model, the method comprising:
providing an initial set of semantic type entities of a specific semantic type;
generating an extended set of semantic type entities, the generating of the extended set comprising expanding the initial set of semantic type entities using available mappings between entities of the initial set and entities of unspecified type;
clustering entities of a same semantic type within the extended set of semantic type entities; and
generating, by a processor, the knowledge data model, the generating of the knowledge data model comprising mapping semantic relations between entities of different semantic type to relations between corresponding clusters containing the entities.

2. The method of claim 1 wherein the mappings comprise ontology mappings of ontologies.

3. The method of claim 2 wherein the ontology mappings are relations between entities of different ontologies defining an equivalence between two different entities.

4. The method of claim 1, wherein the entities of unspecified type are extracted from knowledge resources that form part of a linked open data cloud.

5. The method of claim 4, wherein unstructured textual resources containing text-based documents are automatically integrated in the linked open data cloud.

6. The method of claim 5, wherein unstructured text of the textual resources is linguistically and semantically processed using a semantic data model to extract semantic type entities.

7. The method of claim 6, wherein the extracted semantic type entities are mapped on linked open data entities using string matching and transformed into triple formats extended with links to the linked open data cloud.

8. The method of claim 1, wherein the initial set of semantic type entities comprises an initial disease set, an initial symptom set, or an initial disease set and an initial symptom set.

9. The method of claim 1, wherein the generated knowledge data model is output as a knowledge data model graph, is stored in a database for further processing, or is output as a knowledge data model graph and is stored in a database for further processing.

10. An apparatus for automatically generating a knowledge data model, the apparatus comprising:
a loading unit configured to load at least one initial set of semantic type entities of a specific semantic type from a database; and
a processor configured to expand the at least one loaded initial set of semantic type entities using available mappings between entities of the at least one initial set and entities of unspecified type to generate an extended set of semantic type entities, the processor further configured to cluster entities of a same semantic type within the extended set of semantic type entities,
wherein semantic relations between entities of different semantic type are mapped to relations between corresponding clusters containing the entities to generate the knowledge data model.

11. The apparatus of claim 10, wherein the mappings comprise ontology mappings of ontologies stored in the database.

12. The apparatus of claim 10, wherein the entities of unspecified type are extracted from resources forming part of a linked open data cloud connected to the apparatus by a data interface.

13. The apparatus of claim 10, further comprising a graphical user interface,
wherein the generated knowledge data model is output as a knowledge data model graph via the graphical user interface, is stored in a database for further processing, or is output as a knowledge data model graph via the graphical user interface and is stored in a database for further processing.

14. A linked open data (LOD) cloud system comprising:
a plurality of linked data resources; and
an apparatus comprising a processor, the apparatus configured to:
provide an initial set of semantic type entities of a specific semantic type;
expand the initial set of semantic type entities using available mappings between entities of the initial set and entities of an unspecified type to generate an extended set of semantic type entities;
cluster entities of a same semantic type within the extended set of semantic type entities; and
map, with the processor, semantic relations between entities of different semantic type to relations between corresponding clusters containing the entities to generate the knowledge data model.

15. A model generation software tool for automatically generating a knowledge data model, the model generation tool comprising:
program instructions executable by a processor, the program instructions comprising:
providing an initial set of semantic type entities of a specific semantic type;
expanding the initial set of semantic type entities using available mappings between entities of the initial set and entities of an unspecified type to generate an extended set of semantic type entities;
clustering entities of a same semantic type within the extended set of semantic type entities; and
mapping semantic relations between entities of different semantic type to relations between corresponding clusters containing the entities to generate the knowledge data model.

16. A data carrier configured to store a model generation software tool, the model generation software tool comprising:
program instructions executable by a processor, the program instructions comprising:
providing an initial set of semantic type entities of a specific semantic type;
expanding the initial set of semantic type entities using available mappings between entities of the initial set and entities of an unspecified type to generate an extended set of semantic type entities;
clustering entities of a same semantic type within the extended set of semantic type entities; and
mapping semantic relations between entities of different semantic type to relations between corresponding clusters containing the entities to generate the knowledge data model.
